(19) United States
(12) Patent Application Publication
(10) Pub. No.: US 2008/0025245 A1
(43) Pub. Date: Jan. 31, 2008

(54) Provision of wireless telephone, television and positioning services

(76) Inventors: Justin P. Sweeney, Toronto (CA); John S. Koperwas, Toronto (CA)

Correspondence Address: Gowling Lafleur Henderson LLP;1 First Canadian Place, Suite 1600, 100 King Street West, Toronto, ON, M5X 1G5, US

(21) Appl. No.: 11/493,795

(22) Filed: Jul. 27, 2006

(51) Int. Cl. H04B 7/185

(52) U.S. Cl. 370/317

(57) ABSTRACT

An apparatus for providing wireless telephone, television and positioning services to an allocated space at a venue having alterable space allocations is provided. The apparatus includes a wireless communication sub-system configured to couple the apparatus to a wireless network to receive the services via respective sub-systems. A telephone connection sub-system is configured to wirelessly couple a telephone communication device such as a POTS telephone or point of sale (POS) device to receive the telephone services. A television connection sub-system is configured to wirelessly couple a television to receive the television services. A positioning sub-system is configured to wirelessly couple the apparatus to receive the positioning services. The positioning sub-system comprises a positioning device (e.g. GPS chipset/radio) to obtain positioning data for the apparatus to provide to the positioning services. The apparatus may also comprise an independent power supply for providing power to the apparatus and any telephone communication device.

### FIELD OF THE INVENTION

This invention pertains to a system and apparatus for providing wireless telephone, television and positioning services.

### BACKGROUND OF THE INVENTION

Telecommunication services, television services and other data exchange services at convention or trade show venues are often limited. As a result, the sorts of activities, and as a result the ultimate commercial success, of the convention and or trade show are similarly limited.

Those centers that do provide improved facilities often do so at a high cost, requiring significant labor costs and physical installation of a telephone line and/or coaxial video cable/cord at every location that requires service. Thus, POTS and/or CATV service provisioning is very expensive and inefficient to deploy in commercial facilities where services are constantly being installed and removed, and the physical layout or space allocation varies from event to event.

There remains a need for a method and system that mitigates or obviates at least some of the above problems.

### SUMMARY OF THE INVENTION

An apparatus for providing wireless telephone, television and positioning services to an allocated space at a venue having alterable space allocations is provided. The apparatus includes a wireless communication sub-system configured to couple the apparatus to a wireless network to receive the services via respective sub-systems. A telephone connection sub-system is configured to wirelessly couple a telephone communication device such as a POTS telephone or point of sale (POS) device to receive the telephone services. A television connection sub-system is configured to wirelessly couple a television to receive the television services. A positioning sub-system is configured to wirelessly couple the apparatus to receive the positioning services. The positioning sub-system comprises positioning device (e.g. GPS chipset and radio) to obtain positioning data for the apparatus to provide to the positioning services. The apparatus may also comprise an independent power supply for providing power to the apparatus and any telephone communication device.

The telephone service provider may comprise a public switched telephone network. The telephone service provider may further comprise a SIP server PBX. The television service provider may be a cable television service provider. The positioning service provider may provide Global Positioning System (GPS) services. The wireless access point is preferably a TCP/IP based communication device and preferably provides access to a TCP/IP network including Internet access to any Internet service provider.

In another aspect, there is provided a system for providing wireless telephone, television and positioning services to a plurality of allocated spaces at a venue having alterable space allocations. The system comprises a local area network providing telephone, television and positioning services where the local area network is configured to communicate wirelessly via at least one access point accessible at the venue; and, for use at respective allocated spaces, a plurality of apparatuses in accordance with the apparatus aspect as described above.

In a further aspect, there is provided a method of providing telephone, television and positioning services to an allocated space at a venue having alterable space allocations. The method comprises establishing a local area network providing telephone, television and positioning services where the local area network is configured to communicate wirelessly via at least one access point distributed at the venue; allocating spaces at the venue to respective users; and distributing to each user desiring said services at the user's allocated space an apparatus in accordance with the apparatus aspect described above.

Advantageously, telephone, television and positioning services may be provided via a wireless network at a venue, particularly one having alterable space allocations, and where such telephone services are provided to legacy telephone communication devices such as POTS telephones, point of sale devices, etc.

### BRIEF DESCRIPTION OF THE FIGURES

FIG. 1 is a topological diagram of a system for providing wireless telephone, television and positioning services;

FIG. 2 illustrates a block diagram of an apparatus for use in the system of FIG. 1;

FIG. 3 illustrates the steps in a method for delivering wireless POTS in the system of FIG. 1;

FIG. 4 illustrates the steps in a method for delivering GPS location information in the system of FIG. 1; and,

FIG. 5 illustrates the steps in a method for delivering wireless CATV service in the system of FIG. 1.

### DETAILED DESCRIPTION

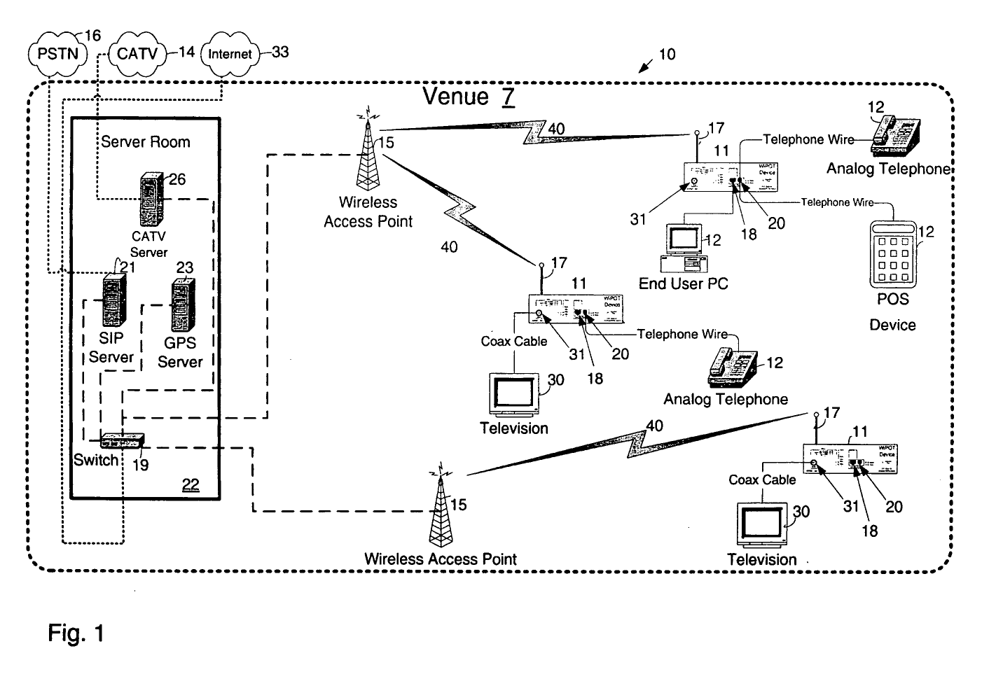

Referring to FIG. 1, a system 10 for providing wireless telephone, television and positioning services to an allocated space at a venue 7 having alterable space allocations is illustrated. The system 10 comprises at least one apparatus 11, which in turn comprises a telephone connection subs-system (represented by telephone connector 20), a television connection sub-system (represented by television connector 31) and a positioning sub-system, each of which subs-systems are in wireless communication with wireless access point 15 available at the venue 7. Each of the access points 15 at the venue 7 is in turn in communication with respective telephone, television and positioning service providers (16, 14 and 33). The telephone connector 20 is configured to couple a telephone communication device 12 (E.g. POTS analog telephone) configured to send and receive telephonic communications. The television connector 31 is configured to couple a television 30 configured to receive a television signal from the television service provider 14. The positioning connector is configured to communicate with an associated positioning device configured to receive from the positioning service provider positioning information corresponding to the apparatus' position. The apparatus may also comprise a power supply (not shown) independent of any venue provided power supply.

The system 10 comprises wireless POTS termination apparatus 11 each with a female RJ-45 18 and RJ-11 20 connectors. The apparatus 11 is a component apparatus of the Wireless POTS, TV and GPS Location System 10, with the wireless POTS apparatus 11 being located at a respective allocated space of venue 7 such as inside a commercial building or residence or at an outdoor concert, etc. The system 10 further comprises a local wireless network such as an 802.1× Wi-FI and/or Wi-MAX network represented by access points 15. The front end user aspect of the apparatus 11 connects to the CPE (Customer Premise Equipment) (i.e. a credit card authorization machine or direct payment point of sale machine, telephone, personal computer, etc.), shown as 12 and/or television 30 respectively. The antenna radio portion 17 of the wireless POTS apparatus 11 communicates with the wireless access point 15 located inside or outside the (not shown) venue 7, which in turn is connected to a network data switch 19 typically located at the venue 7 (and is the responsibility of the telecommunications and/or relevant service provider). Once the end user takes possession of the apparatus 11, installation of telephonic CPE 12 can take place by inserting the line cord of the CPE 12 device into the appropriate RJ-11 POTS port 20. Television 30 may be connected to a coax cable connector 31. A PC 12 may be connected for TCP/IP communication to RJ-45 connector 18.

Wireless POTS apparatus 11 communicates wirelessly via one of a plurality of access points 15 and to a local area network (LAN) (for convenience represented by a switch 19) such as a TCP/IP based network (e.g. Ethernet). LAN 19 is coupled to servers such as SIP server 21, GPS server 23 and CATV server 26 providing respective Session Initiation Protocol (SIP), positioning and television services to user devices coupled to the LAN such as those coupled via wireless POTS apparatus 11. SIP Server 21 may comprises a LINUX® server PBX that receives, routes and transmits data from an IP network to a public switched telephone network (PSTN) such as network 16. Such data is typically encrypted in accordance with known protocols.

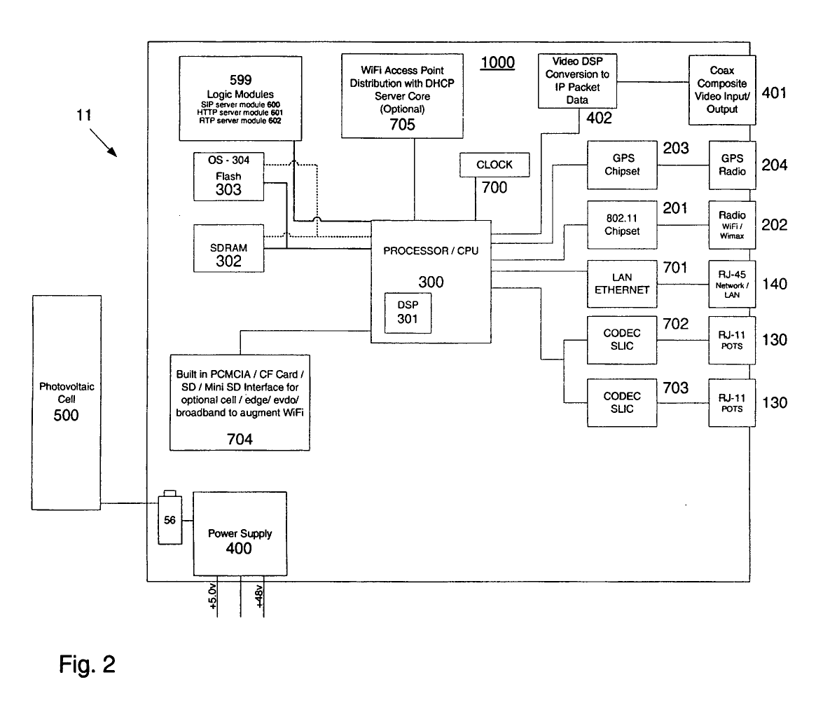

FIG. 2 illustrates a block diagram of internal components in an exemplary wireless POTS apparatus. The description of FIG. 2 is intended to provide a general description of a wireless POTS apparatus in conjunction with the various exemplary chipsets described herein. It will be understood that other types of CPU's, DSP's, connectors, GPS chipsets, codec's and chipsets may be used as well.

Referring to FIG. 1 and FIG. 2, the wireless POTS apparatus 11 (equipped with a GPS chipset 203) can also support end user 911 type emergency access by means of GPS location acquired co-ordinates to a GPS/911 positional access server identified as 23 which can be locally hosted on the premises or (not illustrated here) external to the premises. The GPS co-ordinates are relayed from the wireless POTS apparatus 11 to the GPS Server 23 which correlates received data from the wireless POTS apparatus 11 GPS chipset 203 and 204 (FIG. 2) against pre-selected/installed dimensional statistics database (usually AutoCAD®, etc.) descriptive of the environment of venue 7 in which the wireless POTS apparatus 11 resides. From this database cross referencing procedure specific location information with respect to the end user and/or wireless POTS apparatus 11 may be sent to relevant security personnel in the building. Further, this information may be automatically transmitted to relevant emergency personnel. For example, police, paramedics, fire dept., and others, within the scope of this disclosure can exercise appropriate action based on the additional information relayed to them by the Wireless POTS, TV and GPS Location System 10.

The wireless access point 15 connects to the wireless POTS apparatus 11 through the Wi-FI and/or Wi-MAX 802.1× radio and chipset 201 and 202 (FIG. 2). The chipset 201 is located within the wireless POTS apparatus 11 and is preferably a PCMCIA, CF Flash, or SD Card, and is used to decrypt and/or encode packets of digital data within the wireless POTS apparatus 11 for delivery to the CPU 300 and DSP (Digital Signaling Processor) chip block 301. In practice, an embedded silicone circuit board 1000 with etched lithographic copper circuitry is used to connect the 802.1× wireless chipset and CF Flash, PCMCIA and/or SD card radio 704 to the digital signaling processor 301 and CPU 300. The lithographed embedded copper circuitry is joined by CAD enabled laser point solder, but another connector can be used. Any suitable wireless connection technique configured to communicate voice, television and positioning data to the LAN 19 may be used.

Also mounted in the wireless POTS apparatus 11 is a CPU (Central Processing Unit 300), and/or multiple CPU's, illustrated at FIG. 2 block 301 that is for processing data, as generated by the internal 802.1× chipset mounted on the circuit board 1000. As noted above, it will be understood that other combination types of CPU's, DSP's, connectors, GPS chipsets, codec's and chipsets may be used as well.

A user may input control and/or information into the wireless POTS apparatus 11 via an input/output device connected through the RJ-45 interface 140 (FIG. 2). Input devices include, without limitation, a computer, a notebook computer, PDA, and/or other devices known to those skilled in the art. For example, a notebook computer might allow a GUI interface to be utilized to program the apparatus 11.

In an exemplary implementation, the input/output interface 140 (FIG. 2) is an Ethernet LAN port RJ-45 interface connected to the processor 300 that allows the wireless POTS apparatus 11 to be programmed for various functionalities. For example, the input interface may be implemented as a universal serial bus (USB), and/or implemented partially or entirely in software. The input interface 140, whether implemented in hardware or software or a combination thereof, is configurable to receive and transmit data.

The operating system 304, stored in flash 303 includes proprietary software for operation and remote control and may be implemented by operating systems known in the art, such as Linux®, pebble™ Linux, cuLinux™, etc.

The SDRAM module, shown as block 302 is for storage of GPS obtained co-ordinates. Last known position spatial axes are kept in memory as variables in the event a real-time GPS co-ordinate cannot be obtained. Other forms of memory storage can be used, as is known to those skilled in the art.

In an exemplary implementation, the programmed logic modules 599 include a SIP server module 600, a HTTP (Hypertext Transfer Protocol) server module 601, and a RTP (Real-Time Transport Protocol) server module 602 with codec support.

The SIP server module 600 is configurable to provide server services in accordance with the SIP protocol. The HTTP server module 601 is configurable to provide standard HTTP services and protocol of the wireless POTS apparatus 11. The RTP sever module 602 is configurable to provide real time digital content streaming and codec/encryption support.

The processor 300 is configured to execute instructions in the programmable logic modules 599. The processor 300 is also configured to facilitate control among the components in the wireless POTS apparatus 11, as appropriate.

The clocking block 700 is responsible for synchronizing the CPU with attached peripherals and is a common component known to those skilled in the art.

The LAN Ethernet block 701 provides the TCP/IP, control using a full TCP/IP software stack.

The CODEC SLIC block 702 and 703 respectively proved digitizing of Analog telephony signals and vice versa using standard coder, decoder techniques known in the art. Further, the SLIC (subscriber loop interface circuit) is a transformer used to interface with analog high voltage POTS and provides electrical isolation.

The Wi-FI access point block 705 provides distributed connectivity to other Ethernet IP enabled devices by means of an integrated DHCP server core. This can take the form a separate component module and is know to those skilled in the art.

The PCMCIA block 704 provides physical connectivity for additional functionality. The WiPOT can connect to the Internet via a cellular carrier EVDO or EDGE data network. This can enable the apparatus 11 to transmit data over an alternative network where Wi-FI connectivity is not available. This further expands the scope and capability of apparatus 11 outside of an area where Wi-FI and/or Wi-MAX connectivity is not available.

In an exemplary embodiment, the wireless POTS apparatus 11 also includes a COAXIAL F and/or BNC composite input/output connector 401. Referring to FIG. 1, the coaxial composite output interface 30 connects to an output device, such as a monitor, a television, and/or other types of audio/video display devices, to the wireless POTS apparatus 11. In an exemplary embodiment, the output interface (and/or device) may be different than the input interface (and/or device) 140 (FIG. 2). For example, a GUI displayed on a notebook computer may be used to input programmable functionality commands and the coaxial composite output 140 may be viewed separately to display television like content. Though a coaxial output interface 401, 30 show other output interfaces (e.g. S-video, PCA, component video etc.) without appropriate may be used.

It is to be understood that the above described and/or other components defining the wireless communication sub-system, telephone connection sub-system, television connection sub-system and positioning sub-system of the wireless POTS apparatus 11 preferably reside in a single unit.

Also, all of the programmed logic modules 599 may be implemented in hardware and software, utilizing a single CPU processor and DSP 301, if the chipset and hardware modules themselves contain the requisite processor functionality (FIG. 2).

The wireless POTS apparatus 11 provides digital programmable control of the 802.1× radio 202 via the processor 300 and a HTTP GUI interface.

Also within the wireless POTS apparatus 11 is preferably fitted a rechargeable Ni-cad battery cell, or batteries, illustrated at 56 (FIG. 2), as a 9.6 Volt 3000 mAh or similar unit, that is for powering the wireless POTS apparatus 11 circuit board components and radio, and as required by each phone line in the end user location, for source power and transmission from the wireless POTS apparatus 11 to a receiving access point. A power supply or injection source point is shown at 400 to supply power to the circuit board of the wireless POTS apparatus 11 and connecting the unit to an external power source

Also within the wireless POTS apparatus 11 is preferably fitted a solar cell, or cells 500, as an “5×5” or similar unit, that is for trickle charging the wireless POTS apparatus 11 Ni-CAD battery power cell 56, in order to maintain a stabilized independent power source and transmission from the wireless POTS apparatus 11 to a receiving 802.1× wireless access point. The Ni-CAD battery cell 56 coupled to a solar panel 500 as described is merely exemplary. Those skilled in the art will appreciate that still other implementations may be used.

Referring to FIG. 1, an exemplary CATV server 26 within Wireless POTS delivery and GPS Location System 10 is illustrated. In an exemplary embodiment, the CATV Video encoding server 26 is connectable to the 802.1× Wi-FI network via a managed Ethernet TCP/IP switch 19 in a server room 22. For example, the CATV Video encoding server 26 may be connected to the Ethernet TCP/IP network via a single interface (e.g., a 10/100 Base-T PCI Card, 10/100 Base-T PCI-X Card). In this example, the Ethernet network connection may be provided via an internal 10/100 Network Card.

The CATV Video encoding server 26 is also connectable to a standard CATV distribution system 14 that provides audio/video input data via coax cable. In an exemplary implementation, the server is connected to the CATV video distribution system via a PCI video card fitted with an F-connector coaxial CATV interface. The term “coaxial” as used herein includes F, BNC, and/or other termination methods with audio/video I/O capabilities (e.g., NORDX BNC, etc.). Though a CATV source is described, other TV sources may be used (e.g. over-the-air broadcast sources, satellite TV, etc.) Suitable configuration changes to system 10 (e.g. at server 26) may be envisioned to accommodate an IPTV source.

In an exemplary implementation, video over IP packet data may be transferred over the wireless Ethernet TCP/IP network by means of a Video DSP block 402. For example, using a television 30 connected to the coax port 31 mounted on the wireless POTS apparatus 11, an end user can select channels using a CATV tuner commonly deployed in most televisions. In this case, an end user connects standard television equipment fitted with a CATV tuner directly to the wireless POTS apparatus 11 coax port 31. Upon connection of the television 30, the wireless POTS apparatus 11 will automatically emulate a video signal on the coaxial port after decoding the IP packet data transmitted from the CATV server 26 by means of the Video DSP chip FIG. 2 402. In one embodiment, the wireless POTS apparatus 11 may itself be equipped and/or connected to a display (e.g., a monitor, LCD display or the like, etc.) via the coax interface 31.

The process described above is merely exemplary, and their corresponding examples are merely illustrative. Those skilled in the art will appreciate that still other uses of the Wireless POTS, CATV and GPS Location System may be implemented.

As set out above, the wireless POTS apparatus 11 is preferably located in a self powered box, cabinet, or a hardened enclosure that includes Coaxial F CATV video, RJ-11 telephone & RJ-45 LAN Local Area Network) connectors 130 and 140 for connecting it to CPE 12, 30 and a preferred wireless POTS apparatus case 11 is one manufactured by E.D. Products, though any other type of enclosure can also be used within the scope of this disclosure.

The wireless POTS apparatus 11 and system 10 may be configured to transmit encrypted data for secure communications. Any encryption techniques known in the art may be used.

Both SIP and H.323 define a mechanism for call routing, call signaling, capabilities exchange, media control, and supplementary services.

Typically, when the wireless POTS apparatus 11 is wirelessly connected to the LAN 19, the wireless POTS apparatus 11 registers with the SIP server 21. This is a common SIP protocol procedure complied with by SIP-enabled devices so that SIP devices may communicate with the PSTN and demonstrate exemplary legacy telephone features.

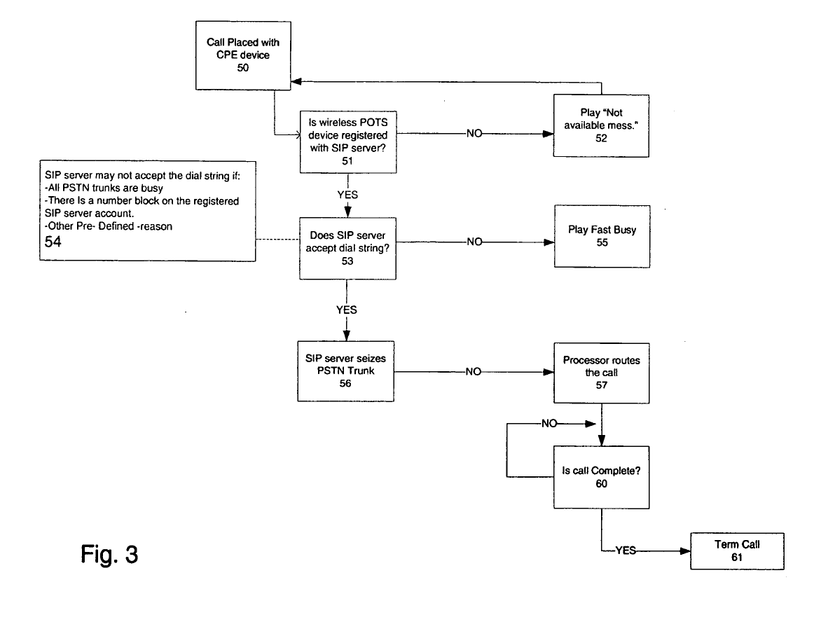

FIG. 3 illustrates a phone call between a source and PSTN target destination external to the wireless network. The SIP server PBX 21 acts as a call router for the duration of the call. In the block flow of FIG. 3, the call and dial string is placed at block 50 using a CPE device (POTS phone 12 of FIG. 1) and, if the wireless POTS apparatus 11 is registered with the SIP server 21, shown at block 51, either an unavailable message, block 52, is received by the CPE and end user, or the SIP server 21 accepts the wireless POTS apparatus as a valid registered client of the system and accepts the dial string, block 53. Alternatively, shown at a block 54 that is connected by a broken line to block 53, the SIP server 21 may not accept the dial string if for example: all trunks to the PSTN are busy; there is a number block on the SIP account particular to the number string entered by the CPE end user; or other pre-defined reason. Additionally, if the destination point either off premises or a locally hosted extension is busy, shown as block 55, the caller receives a busy signal. The dial string from block 53, passes to a call proceed block 56, where, the SIP server connects the wireless POTS apparatus 11 to a PSTN trunk, the call is passed to block 57 where the SIP Server routes the call to the PSTN. The SIP Server continues to route the call, until either party terminates the call, block 60, until terminated, bock 61. This constitutes a POTS phone call to a PSTN party. Advantageously, coupling to the PSTN as described allows a user who subscribes to the services to receive a standard PSTN phone number. The number can have DID (Direct Inward Dial) capability. Thus the user of the apparatus 11 may make and receive calls as any standard telephone user can.

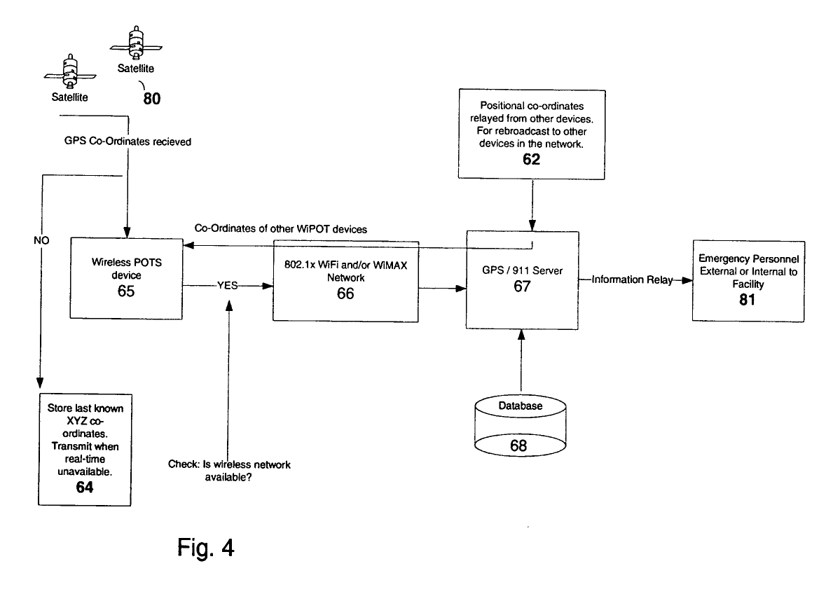

In addition, the system can provide GPS location statistics to Security and/or other identified emergency personnel, to off site security monitoring personnel, Police, Fire and/or emergency medical personnel, as necessary. The GPS/911 server 23 can provide location co-ordinates, to any and all of aforementioned personnel. FIG. 4 shows an example of GPS location transmission where the wireless POTS apparatus 11 is located within system 10. In such a system 10, a wireless POTS apparatus 11, block 65, receives GPS co-ordinates via Satellite system 80 and passes them through the network 19, block 66, to the GPS Server 23, block 67. If no co-ordinates can be obtained, block 64, apparatus 11 then transmits last known co-ordinates stored in its real-time GPS memory. As shown, GPS co-ordinates originated at said wireless POTS apparatus are passed to the GPS server, block 67. GPS Server block 67 cross-references the co-ordinates against the preinstalled facility co-ordinate database 68. GPS Server 23 may transmit the identifiable location information as to the end user's location in the re-allocatable spaces of venue 7 to relevant emergency and/or security personnel block 81 internal or external to the facility as required. The GPS location server can transmit this information via wired or wireless service to end users 81. Once spatial XYZ positions are transferred to the GPS server, this information can then be used to determine relative proximity to other wireless POTS apparatus 11 (see FIG. 1). Also shown block 62 block co-ordinates from other apparatuses on the network provided to GPS Server block 67. GPS data may be rebroadcast to the apparatuses 11 for relative spatial co-ordination between apparatuses 11. This constitutes a GPS/911 location information transfer.

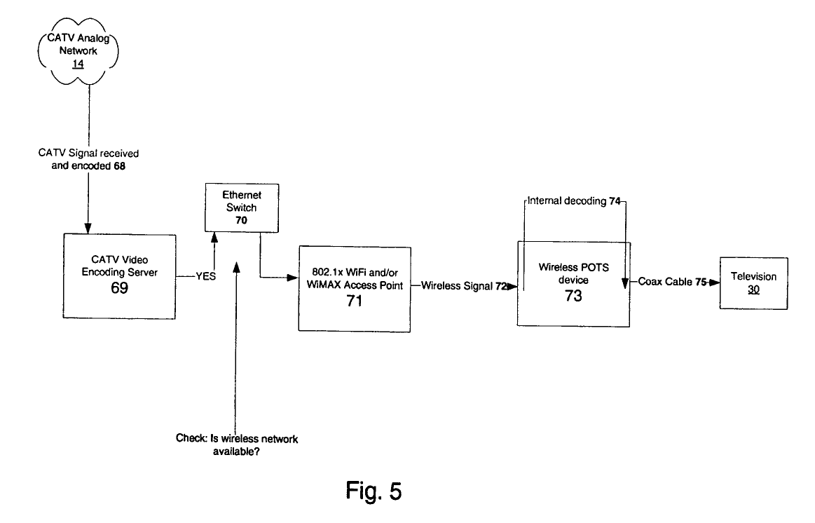

FIG. 5 illustrates a CATV video over IP information transfer to a wireless POTS apparatus 11. A CATV server receiving a signal, block 68, encodes that signal to an Ethernet TCP/IP format through a locally hosted CATV to IP server, block 69. The encoded signal is communicated to an Ethernet TCP/IP network switch, block 70 that passes the TCP/IP packets along to an 802.1× wireless access point block 71. The access point encodes the packets for wireless transmission across an 802.1× radio signal block 72, with said signal being decoded by the wireless POTS apparatus block 73. The CATV transmission data packets are decoded to an analog signal block 74, and delivered to the composite coaxial F and/or BNC or other connector mounted on the wireless POTS apparatus circuit board block 75. This constitutes a CATV video over IP information transfer.

The above is an example of a handling of a CATV type transmission where legacy-type hardwired analog cable is not used throughout the venue 7. For example, such legacy-type televisions as are in common use can access television services through the legacy CATV coaxial cable outlet mounted on the wireless POTS apparatus 11, by means of a CATV video encoding server routing IP video packets wireless into the network 19, thereby allowing CATV to be delivered without the analog transmissions utilizing the legacy Cable TV distribution system at the venue 7.

The process described above is merely exemplary. One skilled in the art will readily appreciate that other types of IP packetized and/or encrypted data may be transmitted as well.

Thus wireless POTS apparatus 11 couple various CPE 12 and 30 via LAN 19 to telephone, positioning and televisions services to provide a system 10 which may be easily established and reconfigured in response to different user requirements in a venue such as a convention or trade show venue (indoor or outdoor), a residence, or other sites such as an emergency response site where entities or persons may require such services. Other venues may include an indoor and/or outdoor venue such as a concert or exhibit where vendors temporarily set up a location at an allocated space in the venue to sell their respective products or services. From one use of the particular venue to the next or the use of the system to the next, the allocated spaces may vary. The number of end users may change and the physical location of the CPE 12 and 13 about a venue 7 may change.

LAN 19 may be established in a desired location at the venue, preferably at a secure and suitable operating environment for servers 21, 23 and 26. Connections are made to PSTN 16, Internet 33, and CATV service 14. The operating environment at the location may be portable such as provided by a trailer positioned at or near the venue and that may be moved between venues such as when traveling between concerts, etc. One or more access points 15 may thus be positioned throughout the venue in accordance with the topology of the venue and the levels of connectivity service desired. Such placement is well known to those of ordinary skill in the art. Wireless POTS apparatus 11 may be distributed for use by users at their respective allocated spaces about the venue such as to convention/trade show exhibitors, vendors or emergency response personnel, etc. Since set-ups at such venues or between venues may differ substantially from one use to the next, appropriate cabling and other infrastructure changes can be minimized using the wireless communication capabilities of the Wireless POTS apparatus 11.

The embodiments of the invention described above are intended to be exemplary only. The scope of the invention is therefore intended to be limited solely by the appended claims.

We claim:

1. An apparatus for providing wireless telephone, television and positioning services to an allocated space at a venue having alterable space allocations, the apparatus comprising:
a wireless communication sub-system configured to couple the apparatus to a wireless network to receive telephone services, television services and positioning services;
a telephone connection sub-system configured to wirelessly couple a telephone communication device to receive the telephone services;
a television connection sub-system configured to wirelessly couple a television to receive the television services; and
a positioning sub-system configured to wirelessly couple the apparatus to receive the positioning services.

2. An apparatus according to claim 1, wherein the telephone services comprise public switched telephone network (PSTN) services.

3. An apparatus according to claim 2, wherein the telephone services are configured in accordance with Session Initiation Protocol (SIP) services and wherein the telephone connection sub-system is configured to provide SIP services to the apparatus.

4. The apparatus according to claim 1, wherein the telephone communication device is a POTS telephone or a point of sale (POS) device and the telephone connection sub-system is configured to facilitate analog telephonic communications with the telephone communication device and digital telephonic communications via the wireless network.

5. The apparatus according to claim 1, wherein the telephone communication sub-system comprises a server configured to provide real-time content streaming services.

6. The apparatus according to claim 1, wherein the positioning sub-system comprises a radio to communicate with a positioning services provider remote from the venue to determine current positional coordinate data for the apparatus and wherein said positioning sub-system communicates the current positional coordinate data via the wireless communication sub-system for the positioning services.

7. The apparatus of according to claim 6 wherein the positioning services determine the position of the apparatus at the venue using the current positional coordinate data.

8. The apparatus according to claim 7, wherein the positioning service provider provides Global Positioning System (GPS) services.

9. The apparatus according to claim 1, wherein the television connection sub-system decodes a television signal received via the wireless communication sub-system to provide as a conventional television signal to the television.

10. The apparatus according to claim 1, comprises an independent power supply.

11. The apparatus according to claim 10 wherein the independent power supply comprises at least one of a battery cell and a photovoltaic energy cell.

12. The apparatus according to claim 1 further comprising a network connection sub-system for coupling a device for communication to the wireless network.

13. The apparatus according to claim 1 wherein the wireless network is configured to communicate using TCP/IP protocols and the wireless communication sub-system is configured to communicate in accordance with at least one of Wi-Fi and Wi-MAX communication protocols.

14. The apparatus according to claim 1 wherein the wireless communication sub-system comprises redundant wireless communication capabilities to optionally communicate wirelessly with a local area network and a wide area network.

15. A system for providing wireless telephone, television and positioning services to a plurality of allocated spaces at a venue having alterable space allocations, the system comprising:
a local area network providing telephone, television and positioning services, said local area network configured to communicate wirelessly via at least one access point accessible at the venue; and
a plurality of apparatus as defined in claim 1 for use at respective allocated spaces.

16. A method of providing telephone, television and positioning services to an allocated space at a venue having alterable space allocations, the method comprising:
establishing a local area network providing telephone, television and positioning services, said local area network configured to communicate wirelessly via at least one access point distributed at the venue;
allocating spaces at the venue to respective users; and
distributing to each user desiring said services an apparatus as defined in claim 1 for use at the user's allocated space.
